(19) United States
(12) Patent Application Publication
(10) Pub. No.: US 2011/0257887 A1
(43) Pub. Date: Oct. 20, 2011

(54) UTILIZATION OF TRACERS IN HYDROCARBON WELLS

(75) Inventors: Iain Cooper, Sugar Land, TX (US); Matthew Miller, Katy, TX (US); Benoit Vidick, Cambridge (GB); Gary Tustin, Sawston (GB)

(73) Assignee: Schlumberger Technology Corporation, Cambridge, MA (US)

(21) Appl. No.: 12/763,260

(22) Filed: Apr. 20, 2010

(51) Int. Cl. E21B 49/00; G01V 9/00; G06F 19/00

(52) U.S. Cl. 702/12; 166/252.6

(57) ABSTRACT

Monitoring of a wellbore which penetrates a reservoir is carried out by providing tracer material at one or more subterranean locations within or proximate the wellbore, so that tracer may enter the flow and be present in flow from the wellbore; repeatedly taking samples from the flow from the wellbore, and analyzing the samples for the presence of tracer, in the vicinity of the wellsite. Taking samples from the flow will generally be done at the surface and may be done by automatic equipment controlled by a programmed computer. The computer may be programmed to take action, such as operating a valve within the well, in response to detection of tracer. Sampling repeatedly and analyzing on site can provide information in something close to real time and thus integrates the use of tracers into an overall process of monitoring and control.

### FIELD OF THE INVENTION

This invention relates to the utilization of tracers in connection with hydrocarbon production and especially in connection with monitoring a wellbore penetrating a hydrocarbon reservoir.

### BACKGROUND OF THE INVENTION

The term tracer has generally been used to denote a material which is deliberately introduced into fluid flow which is taking place. Detection of the tracer(s) downstream of the injection point(s) provides information about the reservoir or about the wellbore penetrating the reservoir. In particular, deliberate addition of tracers has largely been used to observe flow paths and transit times between injection wells (used for instance to inject a water flood into a reservoir) and production wells. For this application of tracers to study inter-well flow, the tracer materials have generally been dissolved in the injection water at the surface before it is pumped down the injection well. As reported by Guan et al. (Journal of Canadian Petroleum Technology May 2005 pages 12 to 15) on the basis of a literature review, the results of inter-well tracer tests are mainly qualitative, although Society of Petroleum Engineers paper SPE 121190 discusses the integration of tracer data into a reservoir simulator program and SPE 124614 is concerned with analysis and interpretation of tracer concentration data.

A deliberately added tracer may be at very low concentration in the produced fluid where it is detected, and a number of prior documents have been concerned with choice of tracer material and/or methods of detection such that the tracer is detectable at very low concentrations. Substances deliberately introduced as tracers have included radioisotopes, fluorine-containing compounds and compounds of rare earth elements. Because the concentrations to be detected are usually low, a number of methods for detection of tracers involve the use of sophisticated laboratory instruments.

For example Society of Petroleum Engineers paper SPE 124689 proposes the use of laser spectroscopy for the detection of krypton isotopes as tracers in gas, but does not discuss collection or handling of material to be tested prior to the passage through an ion source of the spectroscopic apparatus. WO2007/102023 proposes the use of a tracer containing a rare metal (eg caesium, hafnium, silver, gold) which is then detected in a sample by means of inductively coupled plasma mass spectrometry (ICP-MS).

The use of radioisotopes as tracers is often unwelcome because of safety issues and regulations controlling the handling of radioactive material. When other tracers, which tracers do not contain radioactive isotopes, are used it is normal practice that samples are taken from the produced flow and sent away from the well site to a laboratory facility where solvent extraction or other preparative procedure is carried out to extract and/or concentrate the tracer, after which the amount of tracer is determined by an analytical method which may be a sensitive instrumental technique. The sampling and analytical operations are usually carried out with manual handling of the sample. Because of the distance between the well site and the laboratory, there is apt to be a significant time delay between taking the sample and obtaining an analysis of tracer(s) within it. U.S. Pat. No. 7,347,260 relates to this approach of taking samples and sending these for laboratory analysis, as was already known, but seeks to enhance the efficiency by pre-screening samples with a portable device (which may be a portable one time only screening test) in order to select samples to be sent for laboratory analysis.

An alternative approach, mentioned in some documents, is to examine an entire flow stream for a physical property of tracer such as radiation from a radioisotope or fluorescent emission in response to excitation.

Although the literature on the oil-field use of tracers has largely focused on inter-well studies, a few prior documents have proposed placing tracers in a well, or adjacent to it in a perforation extending through well casing into the surrounding formation, so as to observe flow or events within the well rather than investigate flow between wells. For instance, U.S. Pat. No. 5,077,471 proposed injecting radioactive tracers into perforations extending from a wellbore into the rock formation and then observing loss of tracer with a wireline tool. U.S. Pat. No. 5,892,147, U.S. Pat. No. 6,645,769 and U.S. Pat. No. 6,840,316 have all proposed releasing distinguishable tracers from various underground locations within a wellbore and monitoring the produced flow to detect the presence of tracer.

Prior documents have often discussed only a portion of the overall technology of using a tracer, such as the choice of material to use as a tracer or choice of instrumentation to achieve sensitivity to low concentrations in the analytical procedure. Other steps have not been mentioned at all, or have been named without detail. Thus in the documents mentioned above, U.S. Pat. No. 5,892,147 envisaged that tracer material (in particular radioisotopes) is forced into the formation by the explosive when making perforations and will be detectable in the produced flow for a time after production commences. Details of detection are not given. U.S. Pat. No. 6,645,769 named various tracer detection methods as possibilities, but the only one discussed in detail is the detection of fluorescent tracers in the whole flow from the well. U.S. Pat. No. 6,840,316 proposed that tracer should be released from electrically operated equipment positioned below ground. In some embodiments the tracer is detected with sensors below ground while in other embodiments the sensors are at the surface. The nature of the sensors used is not stated and there is no indication that sensors at the surface should be any different from sensors provided below ground. The document apparently contemplates determining tracer concentration by examining the whole flow as it passes a sensor.

### SUMMARY OF THE INVENTION

Broadly, this invention provides, in a first aspect, a method of monitoring a wellbore which penetrates a reservoir, comprising the steps of:
providing one or more tracer materials at one or more subterranean locations within or proximate the wellbore, so that tracer may enter the flow and be present in flow from the wellbore;
repeatedly, and preferably automatically, taking samples from the flow from the wellbore, and
analyzing the samples for the presence of tracer.

The analytical method may be qualitative, to detect the presence of tracer, or may be quantitative, to measure the amount of tracer.

It is expected that sampling of the flow will take place at the surface. If the well site is on land, sampling may take place close to the wellhead where the well emerges from the ground. If the well is located underwater sampling may take place on a drilling platform or production platform to which the well is connected. Whether the well is on land or underwater, it is possible that flow from the well will be conveyed by pipeline for some distance before reaching a point where samples are taken. For instance the flows from a number of wells on land might be piped to a common location on the oilfield concerned and sampling carried out at that location. Flow from an undersea well might be carried for some distance in an undersea pipeline before rising to a production platform where sampling is carried out.

Analysis of samples is preferably carried out at, or in the vicinity of, the location where samples are taken. Analysis may be carried out at the same place as the taking of samples, or analysis may be carried out nearby, such as within 5 Km, better within 2 Km of the location where samples are taken. Sampling and analysis may both be carried out at or near a location from which the well is controlled. This has the advantage that the results of the analysis can become available quickly, so that the information obtained can be used in well control.

Sampling flow, as this invention requires, has advantages compared to examining the entire flow for a physical property characteristic of the presence of tracers, especially when the tracer is not radioactive. Analyzing the entire flow is necessarily confined to analytical techniques which do not harm the material flowing from the well and these are generally tests for a physical property. A sensor for a physical property other than radioactivity, such as a detector for fluorescence, needs to be exposed to the flow in pipework and so become exposed to anything which deposits on the interior of the pipework, for example scale or asphaltene. A thin coating, which would be tolerable on pipework, can interfere with operation of the sensor. Keeping the sensor operational then becomes problematic, potentially requiring the main flow to be shut off in order to carry out maintenance work such as cleaning sensors or to replace a failed sensor. By contrast, if samples are taken from the flow and then tested, the testing equipment can be operated and maintained without interfering with the main flow from the well, even if the testing method is the same.

Sampling the flow and analysis of samples, rather than analyzing the full flow for a physical property, gives greater choice of analytical technique, permitting the use of analytical methods which cannot be applied to a large and moving quantity of material.

Sampling also has the benefit that a portion of the sample can be tested while another portion is retained for a repeat test, if that should be required, or for further, more extensive testing, in the event that an initial test for the presence of tracer gives a positive result. It also provides the option of testing part of the sample at the wellsite, with the advantage of rapid availability of results, while also retaining the possibility to send another part of the sample elsewhere for further analysis if that is called for by analytical results obtained at the well site.

Automated sampling has the benefit that it can provide samples taken at regular intervals while mitigating the possibility of human error in collecting the samples. Carrying out an analysis close to the well site is advantageous in conjunction with automated sampling, because automated sampling facilitates and indeed encourages taking a plentiful number of samples, which can be beneficial, while analysis on site avoids the need to ship a large number of samples to a remote laboratory. A combination of repeated automatic sampling and analysis of samples at the well site can provide a succession of results in something approaching real time.

It is envisaged that the invention is particularly applicable to a well which has multiple entry points for fluid from the formation around the well. For any well architecture where hydrocarbon can enter the well at multiple points, it will be desirable to have qualitative and/or quantitative knowledge of what is flowing into the well at what location, especially if the well completion has incorporated valves for control over the flow from different parts of the well. In accordance with the present invention tracers can be used to distinguish flows from different locations within the well and thus can be used to reveal what is entering the well at various locations.

Thus, in a second aspect, this invention provides a method of monitoring a wellbore which penetrates at least one reservoir and has multiple locations for fluid from the reservoir(s) to enter the wellbore, comprising the steps of:
providing one or more tracer materials at a plurality of subterranean locations within or proximate the wellbore, such that that released tracer may be present in flow from the wellbore;
repeatedly, and preferably automatically, taking samples from the flow from the wellbore, and
analyzing the samples for the presence of tracer, preferably at the location where sampling has taken place or proximate thereto.

Different members of a set of tracers may be provided at respective different locations, so that individual subterranean locations or groups of locations within or proximate the wellbore are distinguished from each other by different tracers associated with them, and detection and identification of tracer identifies the location or group of locations from which the detected tracer was released. It is then desirable that the analytical technique(s) employed have the capability to detect tracer and also identify different tracers. In these circumstances the analytical technique(s) may identify a tracer present in a sample at a detectable concentration, with or without measurement of the concentration of tracer in the sample. It is possible that the flows from more than one well could be mixed before sampling, with the detection and identification of tracer serving to identify both a well and a location therein from which detected tracer was released.

An alternative possibility within this aspect of the invention is to provide equipment for release of tracer from a plurality of subterranean locations within or proximate the wellbore and operate some of the equipment so as to release tracer from a single location or group of locations selected from the overall plurality of locations. In these circumstances operation of equipment to release of tracer may take place under control from the surface and detection of tracer in samples will give information about flow within the well. Because the location of release will be known, it may be possible to use a single tracer material released on command from any chosen subterranean location.

A well with multiple entry points for hydrocarbon may be any of:

a well which penetrates multiple pay zones (i.e. multiple oil-bearing formations);

a well which extends laterally within a reservoir, so that hydrocarbon enters the well at multiple points along the lateral;

a well which branches below ground so as to have multiple flow paths which merge before reaching the surface. A well which branches below ground may have branches diverging at angles to the vertical or may have multiple laterals, or may have both of these.

Tracer materials may be provided at locations distributed within such a well or at locations within the formation and close to the wellbore, such as in perforations. The tracers may be immobilized at the locations where they have been placed and progressively released into the flow over a period of time, possibly after release is initiated by a triggering event. Whenever tracer is placed in the formation adjacent to wellbore, the location at which the tracer is placed and from which it is released into the flow is preferably not more than 1 metre upstream from the point of entry into the wellbore.

Placing tracer at a subterranean location in such a way that it is immobilized there until it is eventually released into the flow is a step which may be carried out when completing the well. The tracer may be thrust into perforations, as taught in U.S. Pat. No. 5,892,147 for instance, or may be immobilized on equipment which is placed in the well when completing it. One possibility is to immobilize tracer by embedding or encapsulating the tracer in the body of material which is exposed to the flow so that the tracer is liberated into the flow as a consequence of diffusion out of the body of encapsulating material and/or degradation of this body of material, analogous to techniques for the controlled release of other oilfield chemicals from encapsulation, described for instance in U.S. Pat. No. 5,922,652, U.S. Pat. No. 4,986,354, U.S. Pat. No. 6,818,594 and U.S. Pat. No. 6,723,683. A body of material which encapsulates tracer may be secured to equipment which is put into the well at the time of well completion. Another possibility is that material encapsulating tracer is applied as a coating on such equipment, for example a coating on the exterior of a tubular.

Another possibility is that tracer may be enclosed within a supply container which is part of apparatus placed in the wellbore at completion and released into the flow by operation of that apparatus, possibly in response to a command from the surface analogously to the proposal in U.S. Pat. No. 6,840,316.

It is also possible that tracer could be delivered to a subterranean location by pumping it from the surface through a pipe (which may be a somewhat flexible pipe of small diameter) running through the structure of the well, example located within the annulus around the production tubing.

This invention provides a tool for monitoring flows within a well, and for detecting events which cause changes to such flows. Monitoring may be carried out over an extended period of time, which contrasts with prior literature which has described the use of tracers to carry out a one-off investigation of flow. Within this general purpose of the invention some applications are envisaged more specifically.

One application of this invention lies in monitoring a well to detect the unwanted penetration of aqueous fluid (often referred to as water although usually a subterranean brine) into a part of the wellbore from the subterranean formation, which of course leads to increased aqueous content in the flow from the part of the wellbore where penetration has occurred. For this application, tracer is positioned in the well such that it is released when in contact with water (more accurately subterranean brine) penetrating into the well so that detection of tracer in the downstream flow provides an indication that water penetration is taking place. It is then desirable that different tracers are associated with respective different entry locations, where water penetration into the well may occur. By using different tracers at different locations within the well bore, the detection of tracer can indicate the part of the well where water penetration is taking place. This is useful in the context of a complex well with control valves which can be used to regulate (for instance to shut off) flow from a part of the well penetrated by water after that part of the well subject to water penetration has been identified by means of the tracer released into the water entering the well.

Another possible application of this invention is to yield information on flow parameters such as flow volumes or flow rates at various locations within a well. In such an application the parameters of interest are likely to be parameters of the flow of hydrocarbon. Such monitoring of flow from different parts of a well may be used in conjunction with control valves able to restrict flow from different parts of the well, aiming to control well flows so that there is more complete drainage of the hydrocarbon reservoir before water penetration takes place.

One approach to determining parameters of flow by means of this invention is to release a quantity of tracer into the flow, possibly in response to a command from the surface or possibly at a predetermined time, and then calculate one or more flow parameters from the time taken for the released tracer to reach the surface. U.S. Pat. No. 5,047,632 discusses the determination of flow rates from concentration data obtained when a single tracer is used or when two tracers are released from a single subterranean location. Similar calculations could be applied to concentration data for each one of a plurality of tracers, released from different individual locations in accordance with this invention.

Another way in which flow parameters may be determined is to release each tracer at a known rate into the passing flow and calculate flow parameters from the concentration of the tracer in the samples of flow taken at the surface. Apparatus for releasing tracer at a known rate from a wireline tool is disclosed in U.S. Pat. No. 4,166,216 and U.S. Pat. No. 6,125,934. Similar apparatus for dispensing tracer could be put in place at a fixed location below ground during completion of the well.

A third approach for determining parameters of flow is to liberate tracer at a rate dependent on the flow rate at the location where the tracer is placed and released. U.S. Pat. No. 6,799,634 discloses an apparatus for this purpose in which a deformable container of tracer material discharges into a venturi, so that the amount of tracer released depends on the pressure drop created by the venturi and hence on the flow rate at that location. If such apparatus is employed for the release of tracers in an embodiment of the present invention, the concentration of each tracer in the samples taken from the flow from the wellbore in accordance with this invention will be indicative of flow velocity at the location where the tracer was placed and released.

This invention is not limited to any specific combination of tracer and method for the detection of tracer. However, it is desirable to adopt a combination of tracer and detection method which facilitates analysis at a wellsite without requiring instrumentation that is dependent on facilities which are normally only available at a fixed laboratory.

The detection method may be one of the various forms of spectroscopy which can be carried out with visible or ultra-violet light. Apparatus for carrying out spectroscopy will generally require an electricity supply, but will not require other services such as carrier gas or vacuum.

More specifically, fluorescent tracers may be used. These are detectable by stimulating fluorescence with ultra-violet or visible light and observing the spectrum of emitted light. As mentioned above this technique has been proposed for examination of the entire flow from a well, but applying it to samples rather than the whole flow has the benefit that equipment maintenance does not interrupt production.

Apparatus for causing and detecting fluorescence will comprise a source of light (which may be visible or ultraviolet light) directed into a sample and a detector for emitted light. Such a detector may observe emission from the sample at a chosen wavelength or over a range of wavelengths. For the identification of tracers, it is desirable to observe the spectrum of the emitted light and this may be done using a diode array detector. Such detectors are often used in the field of liquid chromatography. They may use a holographic grating to split the emitted light according to its wavelength and direct it onto an array of photodiodes.

Another possibility is to choose a tracer capable of being detected by an electrochemical reaction, which may be a redox reaction. This is the subject of a co-pending application entitled “Detection of tracers used in hydrocarbon wells” filed 2 Apr. 2010 with U.S. application Ser. No. 12/753,229.

As disclosed in that application, a tracer may be a redox active material, capable of undergoing a reduction or oxidation reaction within an electrochemical cell, and detection of tracer is carried out by an electrochemical reaction. For the present invention the electrochemical reaction would be applied to material sampled from flow from the well. The tracer may be a water soluble ionic species capable of undergoing a redox reaction. One possibility is a metal ion having more than one oxidation state. For instance copper ions provided by addition of copper sulfate solution can undergo electrochemical reduction to copper metal. The electrochemical reaction may be carried out on a sample of aqueous fluid taken from multiphase flow from the well.

Electrochemical detection of tracer may be carried out using one of the various forms of voltammetry in which potential applied to the electrodes of an electrochemical cell is varied over a range, while measuring the current flow as potential is varied. This may be the well established technique of cyclic voltammetry in which the potential applied to a working electrode is cycled over a sufficient range to bring about the oxidation and reduction reactions while recording the current flow as the potential is varied. The recorded current shows peaks at the potentials associated with the reduction and oxidation reactions. It is also possible that this variation in potential whilst recording current flow could be carried out over only a portion of the reduction and oxidation cycle. This would be classed as linear scan voltammetry.

Cyclic and linear scan voltammetry are customarily performed with a continuous variation of the applied potential over a range, keeping the rate of change sufficiently slow that the analyte is able to diffuse within the electrolyte to reach the working electrode. Further possibilities are that the applied potential is varied in steps (as in square wave voltammetry) or is varied as pulses (as in differential voltammetry for instance). A discussion of various voltammetry techniques can be found in for example Brett and Brett Electrochemistry Principles: Methods and Applications, Oxford University Press 1993. Square wave voltammetry has been found to be effective. In this technique the potential applied to the electrodes is varied in steps superimposed on a progressive variation over a range. The resulting waveform may be such that it can be referred to as a square wave superimposed on a staircase.

As disclosed in the co-pending application mentioned above, a further electrochemical technique which gives very good sensitivity to the presence of some tracer(s) is stripping voltammetry with accumulation. This technique proceeds in two stages. In the first stage the working electrode is maintained at a potential which attracts tracer to become adsorbed onto it, possibly with a redox electrochemical reaction of the tracer on the electrode. The amount of tracer which accumulates is dependent on the concentration of tracer in the solution. Then in a second stage a voltammetric scan is carried out, bringing about electrochemical reaction of the material which has been accumulated on the electrode. This voltammetric scan also strips the accumulation from the electrode. This technique can be used with metal ions as tracers, the metal ions being reduced during the accumulation stage and re-oxidized during the subsequent voltammetric scan.

Because the present invention calls for tracer to be released from a subterranean location which is proximate to or within the well (in contrast with inter-well studies carried out using tracers added to the injected fluid) it is possible and desirable to choose the amount of each tracer and the manner of release with the consequence that the likely concentration of tracer to be detected in flow from the well is predictable. Consequently the amount of tracer provided and its rate of release can be chosen to provide a concentration of tracer which will be detectable by the chosen analytical method.

The amount of each tracer provided and its rate of release at a subterranean location may be chosen to give a concentration by weight of at least 1 part per million in the flow from the well. Detection of such a concentration is less demanding than is sometimes required for inter-well studies. Provision of such a concentration contrasts with the emphasis, in many documents, on choosing tracers which are distinctive in well fluids, even at very low concentration, and choosing analytical methods of great sensitivity capable of detecting tracer concentrations of 10 parts per billion (10 in 10⁹ i.e. 1 in 10⁸) or less, but requiring a laboratory environment.

In some forms of this invention sampling is carried out in a manner which collects a substantially single phase sample from a multiphase flow produced from the well bore. Sampling the flow from a well may be done in various ways. The flow from a hydrocarbon well is usually a turbulent mixture of two or three phases and samples may be taken from one phase after the multiphase flow has been permanently separated into its component phases by a production-scale separator. This separator may be in the vicinity of the well head. Another possibility is to utilize apparatus able to take a sample of one phase from the multiphase flow: an example of such apparatus is described in GB published application GB2447041A. Equipment for measuring multiphase flow and taking single phase samples from the multiphase flow is marketed commercially by Schlumberger under the trademarks “PhaseTester” and “Phase Sampler”. A description of this equipment was given in Oilfield Review, Volume 21 issue 2, Summer 2009, pages 30 to 37.

When analysis gives the concentration of tracer in a single phase sample, this value of concentration may be combined with a separate determination of the quantities of each phase flowing from the well, as obtained with a multi-phase flow meter, to give a value of the quantity of tracer in the overall flow.

Automated sampling may be carried out under control of a timing device operating the sampling equipment at regular, predetermined intervals. More specifically, in some forms of apparatus, automated sampling may be carried out using a computer to determine the timing and operate equipment. Typically the equipment will include means to hold a number of vessels to receive samples and to position each of the vessels in sequence to receive a sample. The same equipment may also carry out the analysis, displaying and recording the results and then moving the sample on, for storage.

The results obtained from analysis of samples may be used to control well operation, especially if the equipment within the well includes valves to regulate or shut off flow from one portion of the well to another. For instance a controlling computer could be programmed such that detection and identification of tracer liberated from a subterranean location as a result of water penetration leads automatically to the closing of a valve in the affected section to prevent further water from entering through that section of the wellbore.

### BRIEF DESCRIPTION OF THE DRAWINGS

FIG. 1 shows a well with a subterranean lateral, in cross-section, together with equipment at the surface;

FIG. 2 shows part of a rotary table and a testing station included in the equipment at the surface;

FIG. 3 shows a well with a plurality of branches, in cross-section, together with equipment at the surface similar to that in FIG. 1;

FIG. 4 shows a section of a subterranean lateral with an alternative way to release tracer;

FIG. 5 shows another form of equipment at the surface; and

FIG. 6 shows apparatus for the electrochemical testing of samples.

### DETAILED DESCRIPTION

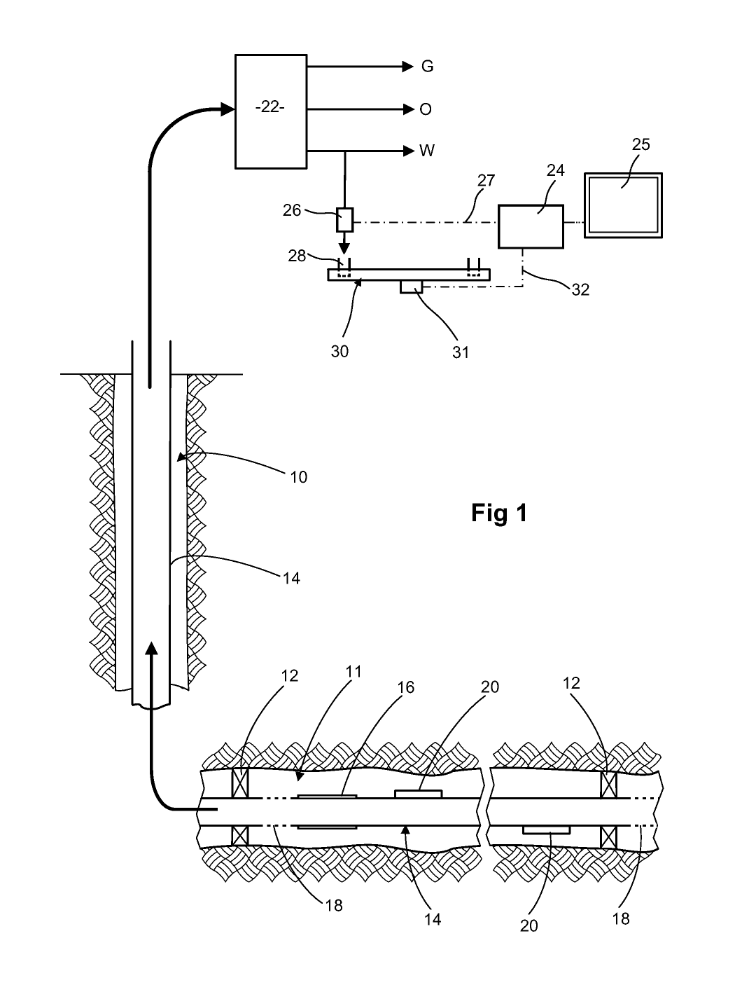

FIG. 1 diagrammatically illustrates a well 10 with a long lateral 11 which is subdivided into sections by packers 12 around the production tube 14. One section between two packers 12 is shown in the lower part of FIG. 1. Within each section there is a valve arrangement which controls entry to the production tube 14. Such a valve arrangement can be of conventional construction. As an example the arrangement shown in FIG. 1 comprises a sliding sleeve 16 which can be moved in response to a command transmitted from the surface so as to cover and close openings 18 for entry of fluid into the production tube 14.

Blocks of material 20 are secured to the exterior of the production tube 14 at each end of this section of the lateral. This material 20 encloses a tracer. Both blocks in this section contain the same tracer, but a different tracer is used in each section. The material of the blocks is such that the tracer is not released if the material 20 is exposed to oil but is released if the material 20 comes into contact with formation water or brine. The material 20 may be water-soluble so as to release tracer as the material 20 dissolves, or maybe water permeable, allowing tracer to dissolve into water which permeates into and out of a block of material 20.

Consequently, so long as oil is entering this section of the well's lateral, the material 20 is exposed only to oil and no tracer is released. However, if water penetrates into this section, tracer will be released into the water and can be detected at the surface.

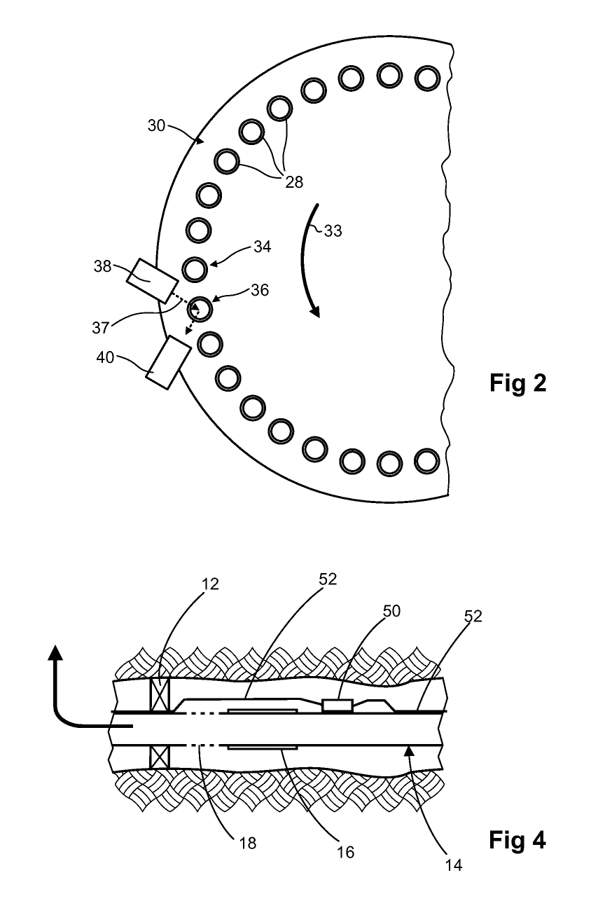

At the well head, the entire flow from the well goes into a production-scale separator 22 which separates the flow into gas G, a liquid oil phase O and a water phase W. A control unit, which here is provided by a computer 24, periodically opens an electrically actuated valve 26 to which it is connected, as indicated at 27, for long enough to release a sample of the water phase. A plurality of sample receiving containers 28 are placed in apertures in a rotary table 30 (shown in plan view in FIG. 2) turned by a drive 31 controlled by computer 24 via connection 32.

After each sample is taken, the control computer 24 operates the drive 31 of the table 30 to turn the table in the direction indicated by arrow 33 sufficiently to move the sample container from position 34 beneath the valve 26 to a position 36 at which the sample is tested. At the same time an empty container 28 is advanced to position 34, ready to receive the next sample. In this illustration the table 30 has spaces for thirty-two sample containers 28 which is enough for a regime of sampling at hourly intervals with the filled containers being replaced with clean empty containers by hand once every day.

At the station 36 a light beam 37 from a source 38 is directed into the sample to excite fluorescence. Any fluorescence is detected by a detector 40 positioned on a line perpendicular to the beam 37 from the source 38.

The source 38 and detector 40 effectively provide a fluorescence spectrophotometer. The source 38 may be monochromatic, a laser for instance, while the detector incorporates a diode detector array so as to be able to detect emitted light over a range of wavelengths and thus observe the spectrum of the fluorescence. This enables the detection and identification of considerable number of tracers with distinctive emission spectra. A further possibility which will obtain even more analytical information is to use a source 38 which emits light at a succession of different wavelengths (for example the source could be provided by lamp and a monochromator) and the fluorescence spectrum could be obtained for each wavelength emitted from this source.

The results from this spectroscopic analysis are processed by the controlling computer 24, recorded on disc and also displayed on the computer's monitor 25.

Detection of tracer at the surface will show that water penetration is occurring (which may of course also be apparent from an increase in the quantity of water produced) but because each section of the lateral is associated with a different tracer, identification of the tracer will also show which section of the lateral has suffered water penetration.

A human supervisor, observing the display on the monitor 25 can then take action to close the valve arrangement, 16, 18 in the section associated with the detected tracer, so as to prevent or restrict water entry while allowing oil production from the other sections of the lateral to continue. Alternatively, the controlling computer 24 may be programmed to both detect and identify tracer from the information which the computer receives from the detector 40 and then close the relevant valve arrangement 16, 18 automatically when tracer is detected.

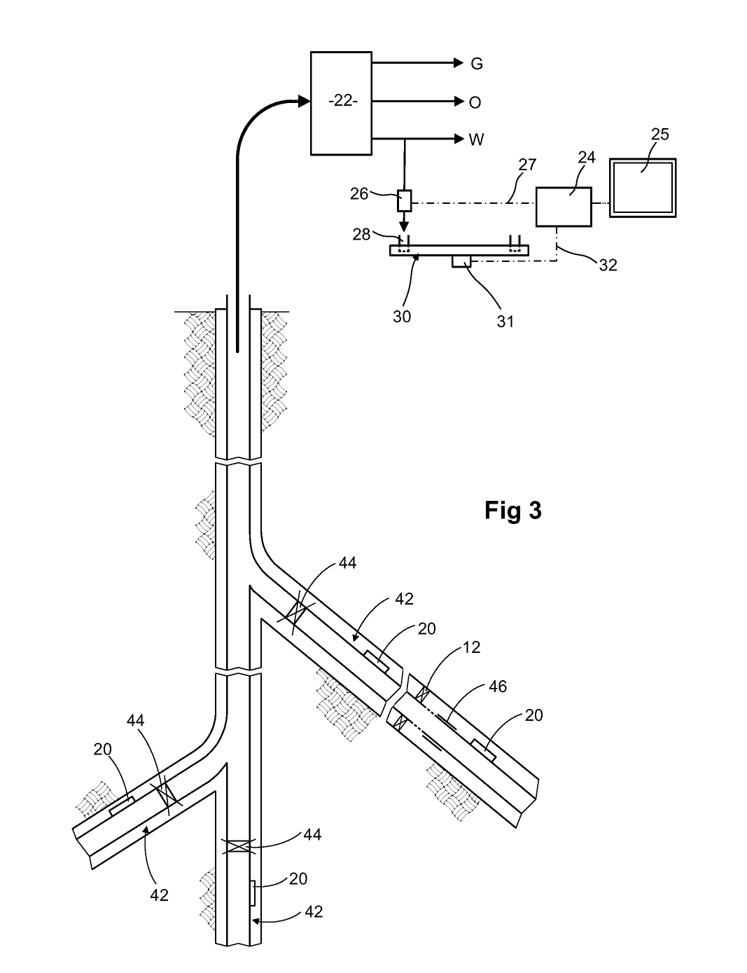

FIG. 3 diagrammatically illustrates a complex well drilled so as to have a plurality of branches 42 which merge below ground. These branches may each be subdivided into sections by packers 12 similarly to subdivision of a lateral as in FIG. 1. Equipment installed at the completion of the well included valves 44 which can be operated to restrict flow from a branch if needed. Further valves 46 which may be sliding sleeves like sleeve 16 can be used to shut off a section of a branch. In particular, one of the valves 44, 46 can be operated to shut off an individual section of a branch or part of a branch if water penetration into the flow becomes significant.

Blocks of material 20 enclosing tracers are secured to the exterior of the production tube 14. The material in each block 20 encloses a tracer (a different tracer in each section of each branch) and is again such that the tracer is not released if the material 20 is exposed to oil but is released if the material 40 comes into contact with formation water or brine. Released tracer can be detected by equipment at the surface, as described with reference to FIG. 1. When tracer is detected and identified at the surface, the affected branch or part of a branch can be shut off by operation of the relevant valve 44 or 46. This may be done by a human supervisor observing monitor 25, or done automatically by the controlling computer 24.

FIG. 4 illustrates a different approach to the release of tracer. Within each section of the lateral or each section of the branch of a multi-branched well, a container 50 of tracer is mounted on the exterior of the production tubing 14.

This container 50 has a controllable outlet which can be operated by command from the surface to deliver a quantity of tracer into the surrounding flow. One possibility is that the container 50 is operated by a built-in battery and controlled by acoustic signals from the surface. Another possibility is that the containers 50 in successive sections of the lateral are all connected to a control line 52 which may be electrical cable or an optical fibre and which runs along the exterior of the production tubing 14. Each container 50 would be constructed to be an addressable by distinctive signals along the line 52 so that tracer could be released from any one chosen container 50 connected to the shared line 52.

In this case it would be possible to use the same tracer material in a plurality of sections of the lateral because it would be known which container 50 had been commanded to release tracer. It is also possible that the control line 52 could include an overall small bore pipe used to replenish the containers 50 as required.

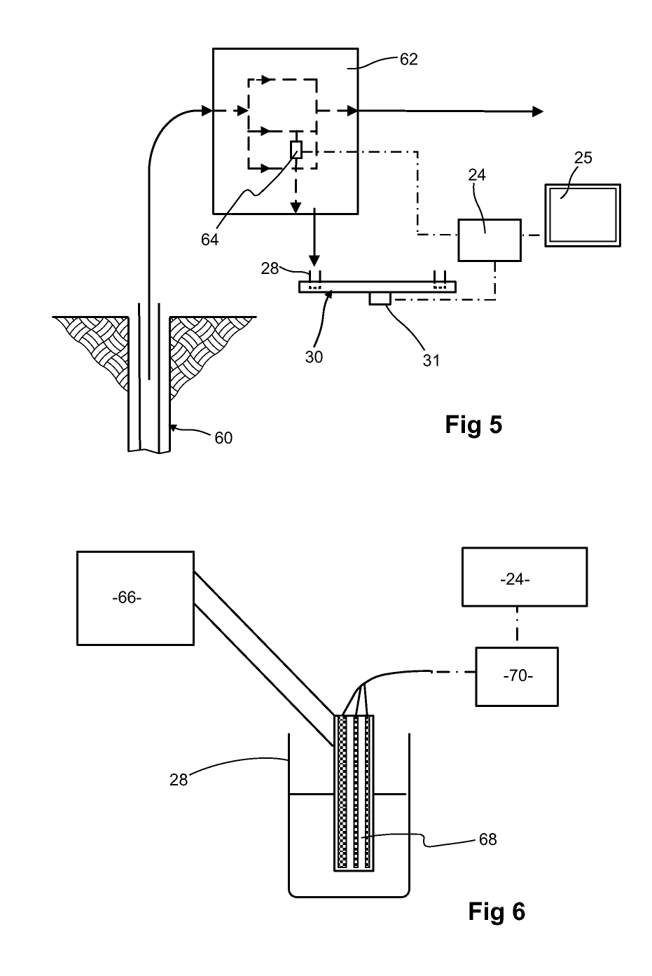

FIG. 5 illustrates another form of surface equipment. The flow from well 60 goes through a piece of apparatus 62 which temporarily separates the flow into gas, liquid oil and water before these separate flows are once again reunited and piped away for further processing elsewhere. Separating apparatus of this kind is described in GB2447041A. This temporary splitting of the flow into three phases allows samples to be taken from a single phase without preventing the entire flow from the well being transported elsewhere by pipeline.

In this illustration the released tracer is oil soluble and samples of the oil phase are periodically and repeatedly collected through valve 64 within the apparatus 62. The samples are collected in containers 28 placed in a rotary table 30 and analyzed as in FIG. 1.

FIG. 6 illustrates the detection of tracer electrochemically, in the manner which is the subject of the co-pending application mentioned above entitled “Detection of tracers used in hydrocarbon wells” filed 2 Apr. 2010 with U.S. application Ser. No. 12/753,229.

When the rotary table 30 moves a collected sample to the station 36, a mechanism 66 (represented schematically) dips a set 68 of three electrodes into the sample in the container 28. These electrodes are in the form of strips deposited on an insulating substrate. A potentiostat 70 is connected to the electrodes and is operated under control of computer 24 to carry out voltammetry serving to detect and quantify tracers present in the sample.

It will be appreciated that the exemplification of this invention given above with reference to the drawings is illustrative but not limiting. Numerous changes and variations are possible. Tracers may be released into the flow in the well in other ways than those shown. The rotary table 30 holding sample containers 28 is only one possibility for collecting samples in containers and moving them on for testing. Numerous other forms of apparatus for collecting and handling samples may be employed.

It is a matter of choice what happens to the samples after they have been tested for the presence of tracer. The samples may simply be discarded or may be kept for a period of time. Possibly, samples in which tracer has been detected may be subjected to further analysis and such further analysis may be carried out at the vicinity of the well head or at a remote laboratory.

1. A method of monitoring a wellbore which penetrates a reservoir, comprising the steps of:
providing tracer material at one or more subterranean locations within or proximate the wellbore, so that tracer may enter the flow and be present in flow from the wellbore;
repeatedly taking samples from the flow from the wellbore, and
analyzing the samples for the presence of tracer.

2. A method according to claim 1 wherein taking samples from the flow is done by automatic equipment controlled by a programmed computer.

3. A method according to claim 1 wherein flow from the wellbore comprises a plurality of phases and the samples from the flow are samples of a single phase.

4. A method according to claim 3 wherein flow from the well is passed through a separator to separate a flow of liquid hydrocarbon from a flow of aqueous liquid and samples are taken from one of these separated liquid flows.

5. A method according to claim 1 wherein analysis of samples is carried out spectroscopically.

6. A method according to claim 1 wherein analysis of samples is carried out by voltammetry.

7. A method of monitoring a wellbore which penetrates at least one reservoir and has multiple locations for fluid from the at least one reservoir to enter the wellbore, comprising the steps of:
providing tracer material at a plurality of subterranean locations within or proximate the wellbore, such that tracer may be released at one or more locations and be present in flow from the wellbore;
repeatedly taking samples from the flow from the wellbore, and
analyzing the samples for the presence of tracer.

8. A method according to claim 7 wherein different tracers are provided at different subterranean locations and analysis of samples identifies any tracer detected, thereby identifying one or more locations from which detected tracer was released.

9. A method according to claim 8 wherein tracers at the subterranean locations are releasable therefrom into flow within the wellbore in response to contact with aqueous subterranean fluid.

10. A method according to claim 9 wherein tracers provided at subterranean locations are encapsulated within water-soluble or water-permeable material.

11. A method according to claim 7 which comprises providing equipment for release of tracer from a plurality of subterranean locations within or proximate the wellbore and operating at least some of the equipment to release tracer into the flow from at least one location selected from the overall number of locations.

12. A method according to claim 7 wherein analysis is carried out within 2 kilometers of the well site.

13. A method according to claim 7 wherein the taking of samples and the analysis of samples are carried out at the same place.

14. A method according to claim 7 wherein a minority of the samples are also sent for additional analysis elsewhere.

15. A method according to claim 7 wherein data from analyzing the samples is transmitted to a computer programmed to calculate parameters of flow at a plurality of locations within the wellbore.

16. A method according to claim 7 wherein data from analyzing the samples is transmitted to a computer programmed to operate equipment within the wellbore in response to the data.

17. A method according to claim 7 wherein taking samples from the flow is done by equipment controlled by a programmed computer.

18. A method according to claim 7 wherein flow from the wellbore comprises a plurality of phases and the samples from the flow are samples of a single phase.

19. A method according to claim 18 wherein flow from the well is passed through a separator to separate a flow of liquid hydrocarbon from a flow of aqueous liquid and samples are taken from one of these separated liquid flows.

20. A method according to claim 7 wherein analysis of samples is carried out spectroscopically.

21. A method according to claim 7 wherein analysis of samples is carried out by voltammetry.
